(19) United States
(12) Patent Application Publication
(10) Pub. No.: US 2026/0161973 A1
(43) Pub. Date: Jun. 11, 2026

(54) INFERENCE APPARATUS AND INFERENCE METHOD

(71) Applicant: NEC Corporation, Tokyo (JP)

(72) Inventor: Kazutoshi HIROSE, Tokyo (JP)

(73) Assignee: NEC Corporation, Tokyo (JP)

(21) Appl. No.: 19/386,428

(22) Filed: Nov. 12, 2025

(30) Foreign Application Priority Data
Dec. 6, 2024 (JP) 2024-213267

(51) Int. Cl. G06N 5/04; G06N 3/08

(52) U.S. Cl. CPC G06N 5/04; G06N 3/08

(57) ABSTRACT

The inference apparatus includes an input size specifying unit that specifies the size of each of multiple input data, a reference size determination unit that determines a reference size, an input data transformation unit that transforms the input data based on the reference size to generate multiple transformed data, a data combination unit that combines the transformed data into one data, and an inference unit that performs inference using the one data as input.

### CROSS-REFERENCE TO RELATED APPLICATION

This application is based upon and claims the benefit of priority from the prior Japanese Patent Application No. 2024-213267, filed Dec. 6, 2024, the entire contents of which are incorporated herein by reference.

### BACKGROUND OF INVENTION

### Field of the Invention

The present disclosure relates to an inference apparatus and an inference method related to multimodal machine learning.

### Description of the Related Art

As a method of neural network inference, there is multimodal processing that handles multiple types of input data simultaneously. When multimodal processing is used, by integrally processing multiple input data, inference accuracy can be improved.

As representative schemes related to integration of input data, there are early fusion and late fusion. Early fusion is a scheme in which multiple input data are combined before inference by a neural network is executed.
[Non patent literature 1] Chi Thang Duong, et al., “Multimodal Classification for Analysing Social Media”, Aug. 7, 2017, Computer Science.

### SUMMARY OF INVENTION

When early fusion is used, the computational cost is reduced compared with late fusion which is high in accuracy but requires a large computational cost. That is, late fusion is a scheme in which data are integrated after inference by a neural network is executed.

When early fusion is used, it is necessary to equalize the sizes of multiple input data. The size of input data can be represented by channel, height, and width. Equalizing the sizes of multiple input data specifically means making at least any two of channel, height, and width equal to the same values. Hereinafter, each of channel, height, and width may be referred to as a dimension.

For example, when multiple input data are given in which both height and width, or either one of them, differ, in order to equalize the sizes of the multiple input data, it is required to enlarge or reduce the input data.

Then, when early fusion, which originally achieves reduction of computational cost, is used, in a case where input data are enlarged, redundant information is added to the input data and the effect of reducing computational cost may be decreased. Moreover, in a case where the input data are reduced, a loss of information may occur and the inference accuracy may deteriorate.

Note that in Non patent literature 1, in addition to early fusion and late fusion as multimodal processing, proposals related to joint fusion and common space fusion are made.

An example object of the present disclosure is to provide an inference apparatus, an inference method, and an inference program that, even when early fusion is used, can suppress a decrease in the effect of reducing computational cost and can suppress a decrease in inference accuracy.

An inference apparatus according to an example aspect of the disclosure includes an input size specifying unit that specifies the size of each of multiple input data, a reference size determination unit that determines a reference size, an input data transformation unit that transforms the input data based on the reference size to generate multiple transformed data, a data combination unit that combines the transformed data into one data, and an inference unit that performs inference using the one data as input.

An inference method according to an example aspect of the disclosure includes specifying the size of each of multiple input data, determining a reference size, transforming the input data based on the reference size to generate multiple transformed data, combining the transformed data into one data, and performing inference using the one data as input.

An inference program according to an example aspect of the disclosure causes a computer to specify the size of each of multiple input data, determine a reference size, transform the input data based on the reference size to generate multiple transformed data, combine the transformed data into one data, and perform inference using the one data as input.

According to the present disclosure, even when early fusion is used, a decrease in the effect of reducing computational cost is suppressed, and a decrease in inference accuracy is also suppressed.

### BRIEF DESCRIPTION OF THE DRAWINGS

FIG. 1 It is a block diagram that explains an example of a configuration of an inference apparatus.

FIG. 2 It is an explanatory diagram that explains an example of processing such as folding of input data.

FIG. 3 It is an explanatory diagram that explains an example of a method of determining a reference size.

FIG. 4 It is an explanatory diagram that explains an example of a method of determining a reference size.

FIG. 5 It is an explanatory diagram that explains an example of a transformation of input data.

FIG. 6 It is an explanatory diagram that explains an example of a transformation process.

FIG. 7 It is an explanatory diagram for explaining a specific example of a transformation process.

FIG. 8 It is an explanatory diagram that explains another example of a transformation process.

FIG. 9 It is an explanatory diagram that explains an example of folding input data in directions related to two dimensions.

FIG. 10 It is an explanatory diagram that explains in more detail folding of input data in directions related to two dimensions.

FIG. 11 It is a flowchart that explains operations of the inference apparatus.

FIG. 12 It is a block diagram that explains another example of a configuration of the inference apparatus.

FIG. 13 It is a flowchart that explains operations of a search unit in the inference apparatus.

FIG. 14 It is a block diagram that explains an example configuration of an information processing system.

FIG. 15 It is a block diagram that explains principal components of the inference apparatus.

### DESCRIPTION OF THE PREFERRED EMBODIMENTS

Hereinafter, example embodiments will be explained with reference to the drawings.

### Example Embodiment 1

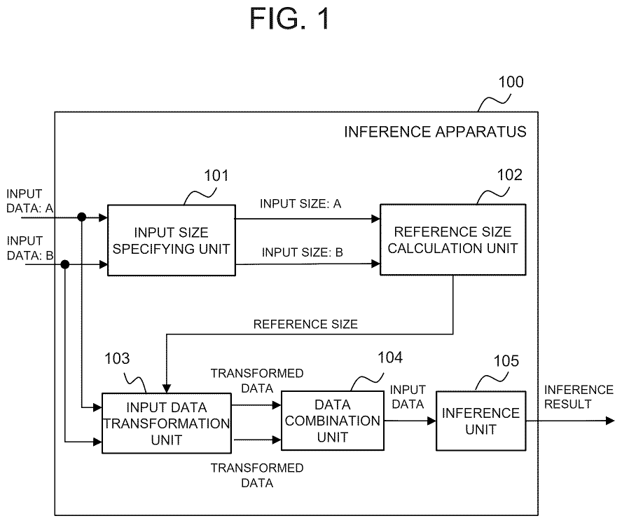

FIG. 1 is a block diagram that explains an example of a configuration of an inference apparatus. An inference apparatus 100 shown in FIG. 1 includes an input size specifying unit 101, a reference size calculation unit 102, an input data transformation unit 103, a data combination unit 104, and an inference unit 105.

The input size specifying unit 101 specifies the size (input size) of each of multiple input data. The reference size calculation unit 102 determines a reference size that is the size of a two-dimensional plane used as a reference based on the input sizes. Note that the two-dimensional plane is defined by height and width.

Although two input data (input data A and input data B) are illustrated in FIG. 1, three or more types of input data may be input to the inference apparatus 100 (specifically, to the input size specifying unit 101).

The input data transformation unit 103 and the data combination unit 104 transform the input data in such a way that their sizes become the reference size and then combine the multiple transformed input data in the channel direction. Specifically, the input data transformation unit 103 performs a transformation process that resizes input data in such a way that a two-dimensional plane of the input data becomes the reference size and folds the input data in the channel direction. The data combination unit 104 combines the multiple transformed input data in the channel direction.

As will be explained later, the input data transformation unit 103, for example, achieves transformation of input data by dividing (partitioning) the input data into multiple data and folding them. The data combination unit 104 combines the transformed input data, that is, multiple data obtained by the transformation, in the channel direction. The data combination unit 104 generates one combined data from multiple data obtained by the transformation. This combined data may be referred to as input data. This input data is input data to the inference unit 105, and although the expression is the same, it is different from the input data to the inference apparatus 100.

The inference unit 105 includes an inference model. The inference unit 105 supplies one input data (one combined data) to the inference model to obtain an inference result. Note that when the inference model is a convolutional neural network, the number of channels in an initial layer (for example, a convolutional layer) is equal to the number of channels of the input data.

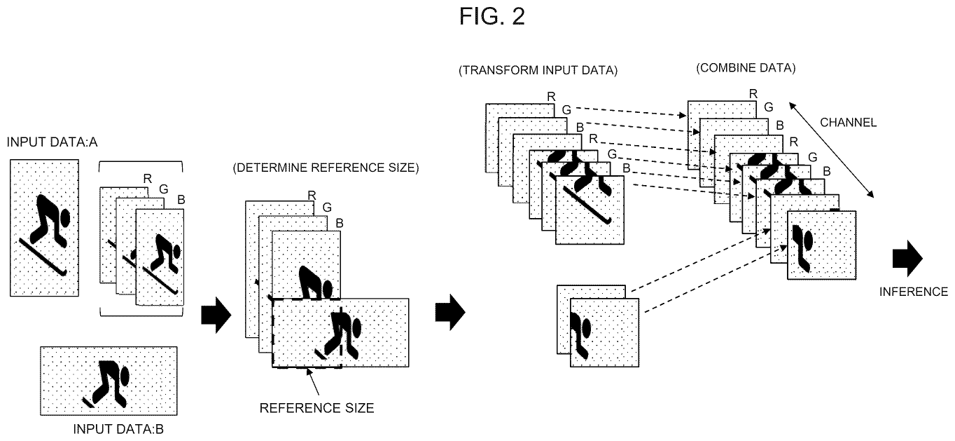

Next, an example of processing of transformation executed by the input data transformation unit 103, that is, processing such as folding of input data, will be explained with reference to FIG. 2.

Hereinafter, as input data A a color image data (hereinafter, a color image) is used as an example, and as input data B a monochrome image data (hereinafter, a monochrome image) is used as an example. That is, the input data A and the input data B are common as images but different in format. However, the input data A and the input data B may be in the same format (in this example, either a color image or a monochrome image). Also, input data to the inference apparatus 100 is not limited to image data. As one example, the input data may be voice data, text data, a radio signal, and the like.

When the input data A that is a color image and the input data B that is a monochrome image are input, the reference size calculation unit 102 determines the reference size based on the input sizes specified by the input size specifying unit 101. The input data transformation unit 103 folds the input data A and the input data B in the channel direction. Specifically, the input data transformation unit 103 divides the input data A and the input data B by the reference size and folds them in the channel direction. As explained above, division and folding of input data are examples of transformation of input data.

The data combination unit 104 combines the transformed data in the channel direction. In the example shown in FIG. 2, the input data A includes R data, G data, and B data, each of which is divided into two, and after transformation becomes data of six channels. The input data B is divided into two and after transformation becomes data of two channels. These two data are combined in the channel direction. The number of channels of the combined data is eight.

Next, the processing such as folding will be explained for a specific example.

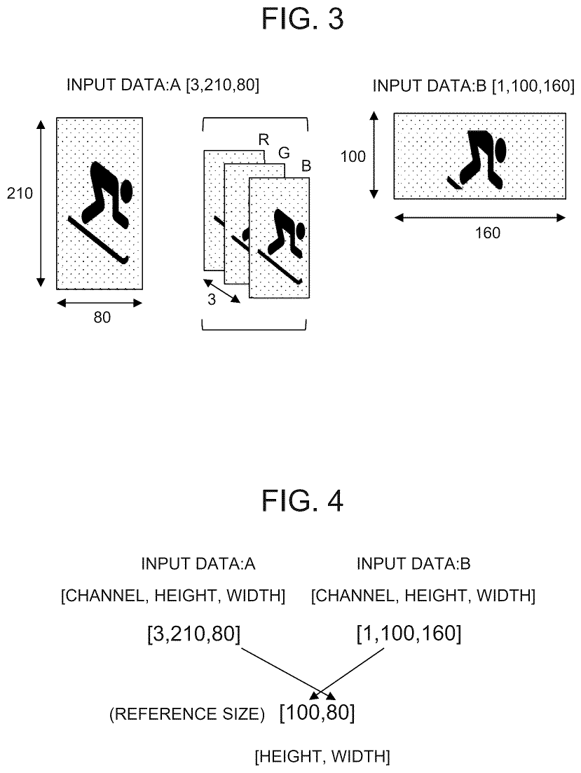

FIG. 3 and FIG. 4 are explanatory diagrams that explain an example of a method of determining the reference size. Hereinafter, the number of channels, height, and width of input data will be represented as [number of channels, height, width]. The height and width of the reference size will be represented as [height, width].

In the example shown in FIG. 3, the number of channels, height, and width of the input data A are [3, 210, 80]. The number of channels, height, and width of the input data B are [1, 100, 160]. In this case, the reference size calculation unit 102 determines the reference size (height, width) as [100, 80].

That is, the reference size calculation unit 102 determines, for each of height and width of multiple input data, the minimum value as the height and the width of the reference size (reference size).

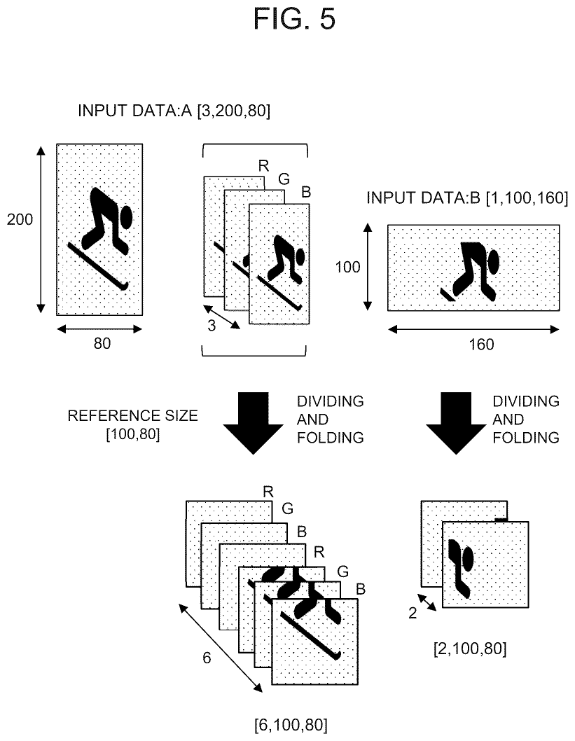

FIG. 5 is an explanatory diagram that explains an example of a transformation of input data.

In the example shown in FIG. 5, the number of channels, height, and width of the input data A are [3, 200, 80]. The number of channels, height, and width of the input data B are [1, 100, 160]. In this case, the input data transformation unit 103 transforms each input data in such a way that the two-dimensional plane of each data matches the reference size. Then, for each of the input data, the input data transformation unit 103 folds transformed data (for example, multiple data obtained by dividing the input data) in the channel direction.

Therefore, in the example shown in FIG. 5, data of a two-dimensional plane having six channels are generated from the three-channel input data A. Also, data of a two-dimensional plane having two channels are generated from the one-channel input data B.

In FIG. 5, for the input data A, an example is shown in which the input data are divided by the reference size in the height direction and folded in the channel direction. For the input data B, an example is shown in which the input data are divided by the reference size in the width direction and folded in the channel direction.

In the example shown in FIG. 5, the sizes of the input data A and the input data B are multiples of the reference size, but the size of input data is not necessarily a multiple of the reference size. When the size of input data is not a multiple of the reference size, that is, when a remainder occurs for the size of input data relative to the reference size, the input data transformation unit 103 adjusts the size of the input data in such a way that it becomes a multiple of the reference size.

As ways of adjustment, the following methods are considered.

First, the input data transformation unit 103 obtains, for each of height and width of the input data, a remainder. For example, when the reference size is [100, 80] and the number of channels, height, and width of the input data are [3, 210, 80], the remainder in the height direction is 210% 100=10. The remainder in the width direction is 80% 80=0. Note that “%” is used as an operator of a modulo operation (an operation to obtain the remainder of a division).

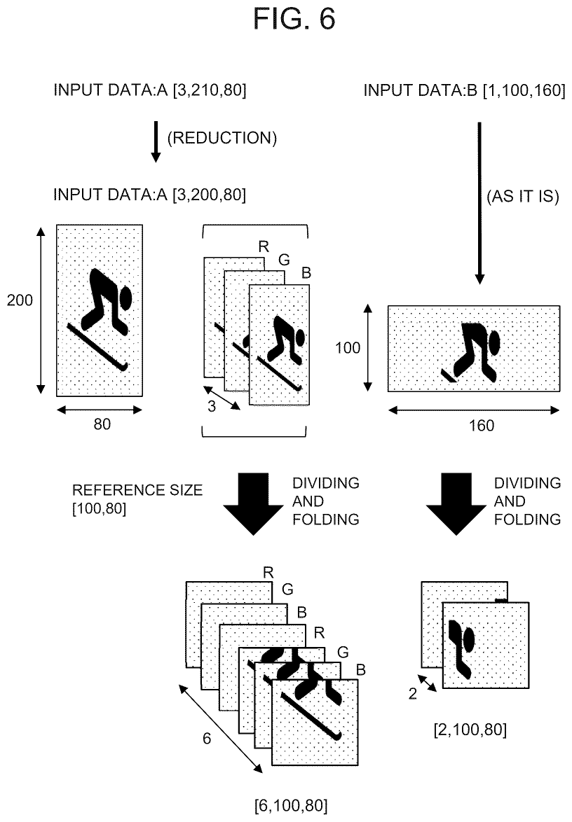

Then, when the remainder is equal to or less than a threshold determined in advance, the input data transformation unit 103 reduces the input data in such a way that the size becomes a multiple of the reference size. FIG. 6 shows an example in which when the height of the input data A is 210, the height is reduced to 200. Note that the threshold is, for example, ½ of the reference size, but a user may arbitrarily determine the threshold. The input data transformation unit 103, for example, achieves reduction of size by thinning pixels of the input data, but may also reduce the size by trimming the input data.

When the remainder is greater than a threshold determined in advance, the input data transformation unit 103 enlarges the size of the input data to a multiple of the reference size on condition that the size does not exceed the original size. For example, when the reference size is [100, 80] and the number of channels, height, and width of the input data are [3, 210, 80], the height is enlarged to 300. The input data transformation unit 103, for example, achieves enlargement of size by interpolating pixels of the input data, but may also increase the size by adding data of zero.

In summary, when the input data transformation unit 103 divides input data by the reference size, if a remainder occurs for the size of input data relative to the reference size, the input data transformation unit 103 executes an adjustment process of resizing the input data and then divides the input data. Note that such an adjustment process is applicable regardless of whether the input data transformation unit 103 uses any of transformation method 1-A, transformation method 1-B, and transformation method 2, which will be explained later.

Also, processing (transformation and folding) after reduction of size or enlargement of size is the same as the processing shown in FIG. 5.

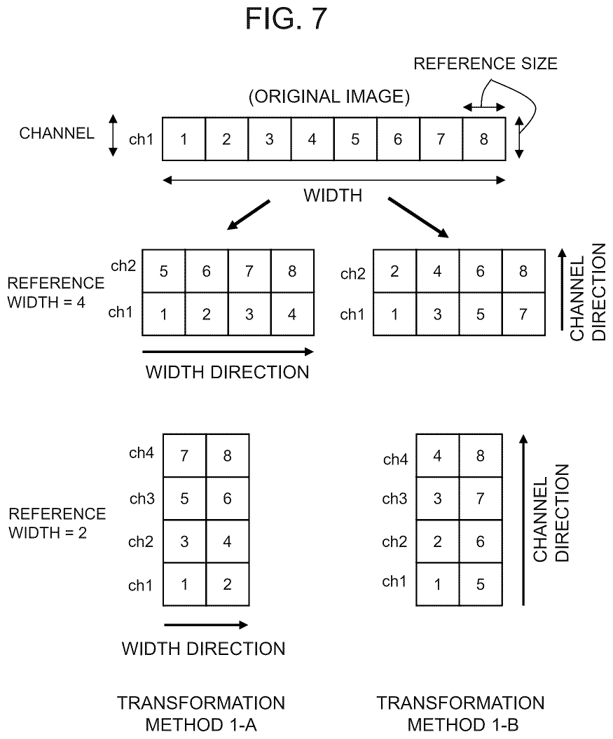

FIG. 7 is an explanatory diagram that explains an example of a transformation process. The transformation process described above is referred to as transformation method 1-A. As shown in FIG. 7, in transformation method 1-A, input data are divided by the reference size in the height direction or the width direction and folded in the channel direction, but a transformation process may be executed in which pixels of input data are folded in such a way as to be sequentially laid out in the channel direction. This transformation method is referred to as transformation method 1-B.

Note that in FIG. 7, the numbers in rectangles correspond to pixel indices. A reference width (which corresponds to the number of pixels when the input data are images) is the width of the reference size. In FIG. 7, for transformation method 1-A, an example is shown in which input data are divided by the reference size in the width direction and folded, but in a case where input data are divided by the reference size in the height direction and folded, processing is performed similarly to the case of the width direction.

The following transformation process can also be executed. The following transformation process is referred to as transformation method 2.

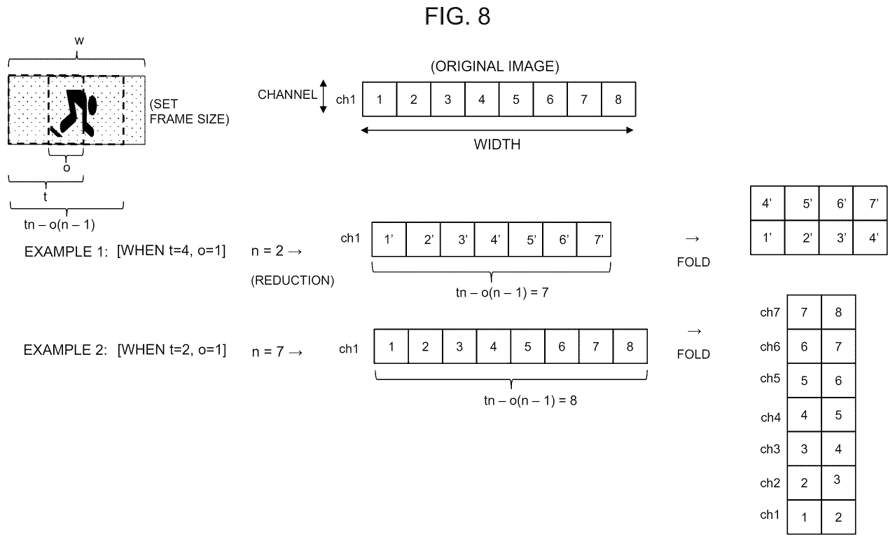

As shown by broken lines in FIG. 8, multiple frames of the reference size are set for the input data. The multiple frames overlap. FIG. 8 shows an example in which two frames are set. Note that FIG. 8 illustrates a case in which the size of the input data is not a multiple of the reference size.

The input data transformation unit 103 executes the transformation process including a region that overlaps. Specifically, the transformation process is executed as follows.

Assume that the width of the original image is w and the width of the reference size is t. Also, assume that the width of an overlapping region (overlap width) is o. The overlap width can be set arbitrarily. Then, the input data transformation unit 103 obtains a number of divisions n in the width direction.

The number of divisions n is a value that minimizes the difference between w and a width immediately before folding, {t n−o (n−1)}, as expressed by Equation (1).

$$\begin{matrix}[ Math . 1 ] & \\ {arg min}_{n ∈ ℕ} \vert w - \{ t n - o ( n - 1 ) \} \vert & Equation ( 1 )\end{matrix}$$

The input data transformation unit 103 resizes (enlarges or reduces) input data of width w to {tn−o (n−1)}. Then, the input data are folded by the reference size in such a way that they overlap with width o. Note that when w={tn−o (n−1)}, the input data transformation unit 103 does not resize the input data.

That is, the input data transformation unit 103 extracts multiple regions of the reference size from the input data, and when a remainder occurs for the size of the input data relative to the reference size, performs an adjustment process of resizing the input data in such a way that the remainder is eliminated.

In FIG. 8, Example 1 is shown where the reference width is 4 and the overlap width o is 1. In Example 1, n=2. In Example 1, since w> {tn−o (n−1)}, the input data are reduced. Also, since the number of divisions n=2, the input data are divided into two. Note that, in the data after folding, pixel 4′ is a pixel that overlaps.

Also, Example 2 is shown where the reference width is 2 and the overlap width o is 1. In Example 2, n=7. Since the number of divisions n=7, the input data are divided into seven. Pixels having pixel indices 2 to 7 are overlapping pixels.

In the explanation above, mainly a case was used as an example in which input data are folded in the width direction. Even in a case where input data are folded in the height direction, the same idea as in the case where they are folded in the width direction can be applied.

Note that it is possible to transform input data in both the width direction and the height direction, and in that case, either transformation method 1-A or transformation method 1-B explained above may be used for each direction. Moreover, the transformation method for the width direction and the transformation method for the height direction may be different. For example, one may use the transformation method 1-A or 1-B explained above for the width direction and use the transformation method explained above for the height direction. Also, one may use transformation method 2 explained above for the width direction and use transformation method 1-A or 1-B explained above for the height direction.

When resizing input data, the input data transformation unit 103 may uniformly enlarge or reduce both in the width direction and in the height direction. Also, the overlap width may be the same for the width direction and the height direction, or may be different between the width direction and the height direction.

In the explanation above, input data were divided by the reference size in the height direction or the width direction and folded in the channel direction. That is, data divided with respect to one dimension in input data were folded in a direction related to another one dimension (specifically, the channel). However, input data can also be folded in directions related to multiple other dimensions with respect to data divided with respect to one dimension. The following transformation process is referred to as transformation method 3.

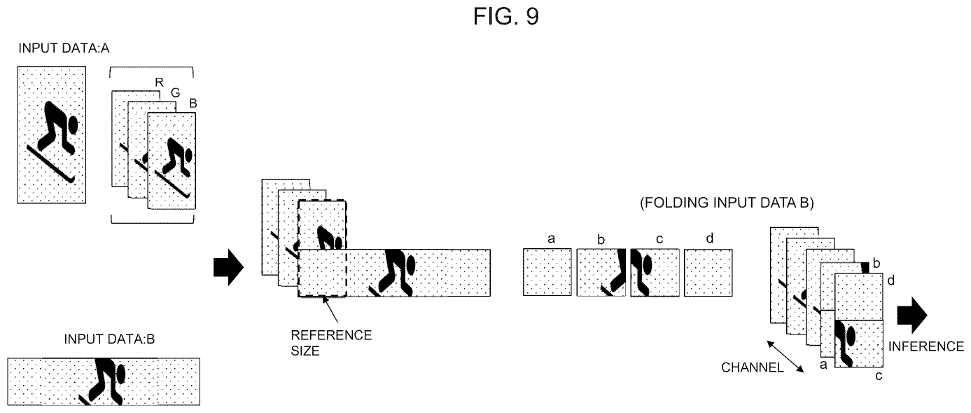

FIG. 9 is an explanatory diagram that explains an example of folding input data in directions related to two dimensions. In FIG. 9, taking the size of input data A that is a color image as the reference size, an example is shown in which input data B that is a monochrome image are divided in the width direction and then folded in the height direction and the channel direction.

Specifically, the input data B are divided into data (images) a to d, data a and b are folded in the height direction, and data c and d are folded in the height direction. Furthermore, combined data consisting of data a and b and combined data consisting of data c and d are folded in the channel direction. The order of folding in the height direction and the channel direction may be such that the channel direction comes first.

Note that when data (images) are folded in the height direction, margins may be added to data a to d in order to avoid interference with neighboring pixels.

Hereinafter, folding of data (images) in some direction may be referred to as arranging data. That is, dividing data into multiple data and arranging the data in a direction of some dimension may be referred to as arranging data. Note that processing of dividing data and processing of arranging data are executed by the data transformation unit 103.

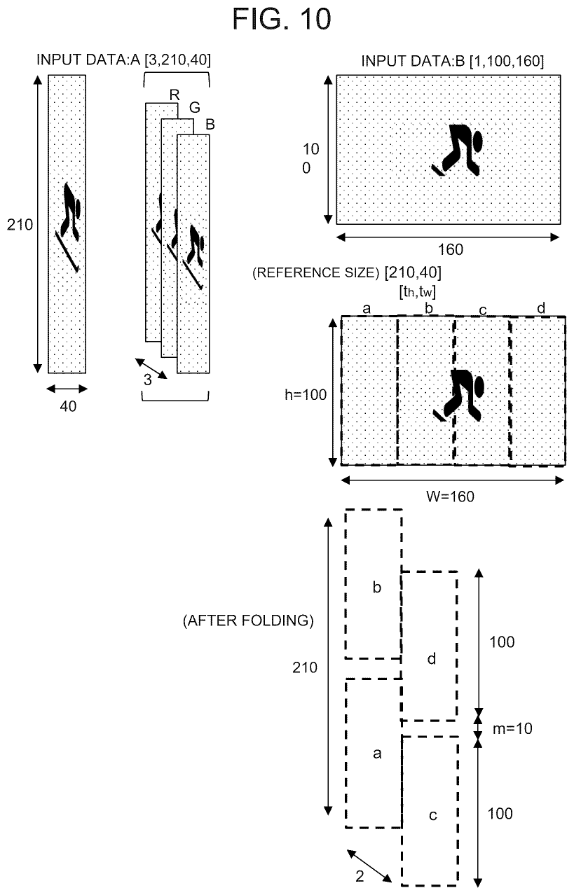

FIG. 10 is an explanatory diagram that explains in more detail folding (division and arrangement) of input data in directions related to two dimensions. In FIG. 10 as well, an example is shown in which input data B are divided in the width direction and data (images) a to d obtained by division are arranged in the height direction and the channel direction.

Since the dimension related to folding (folding direction) is the width direction, a minimum value among widths of the respective input data is used as the width of the reference size. Also, since input data are also folded in the height direction, a maximum value among heights of the respective input data is used as the height of the reference size.

As an example, [3, 210, 40] is used as the number of channels, height, and width of the input data A. As an example, [1, 100, 160] is used as the number of channels, height, and width of the input data B.

Let tₕ and t_{w} denote the height and width of the reference size. Let h and w denote the height and width of input data targeted for folding. Also, set a margin width m. The margin width m is set, for example, by a user.

The input data transformation unit 103 obtains a number of times (number of divisions) nₕ for folding the input data targeted for folding (in the example shown in FIG. 10, the input data B) in the height direction.

The number nₕ is a value that minimizes {tₕ−{h nₕ+m (nₕ−1)}} as expressed by Equation (2). In the example shown in FIG. 10, nₕ=2.

$$\begin{matrix}[ Math . 2 ] & \\ {arg min}_{{n}_{h} ∈ ℕ} \vert {t}_{h} - \{ h {n}_{h} + m ( {n}_{h} - 1 ) \} \vert & Equation ( 2 )\end{matrix}$$

The input data transformation unit 103 also obtains a number of times n_{c} for folding the input data targeted for folding (in the example shown in FIG. 10, the input data B) in the channel direction.

The number n_{c} is a value that minimizes {w−t_{w} nₕ n_{c}} as expressed by Equation (3). In the example shown in FIG. 10, n_{c}=2.

$$\begin{matrix}[ Math . 3 ] & \\ {arg min}_{{n}_{c} ∈ ℕ} \vert w - {t}_{w} {n}_{h} {n}_{c} \vert & Equation ( 3 )\end{matrix}$$

Furthermore, the input data transformation unit 103 enlarges or reduces the input data in such a way that the height h and the width w of the input data targeted for folding (in the example shown in FIG. 10, the input data B) become the values below. The input data transformation unit 103 may perform trimming or setting to zero.

$$h = ( {t}_{h} = m ( {n}_{h} - 1 ) \} / {n}_{h}$$

$$w = {t}_{w} {n}_{h} {n}_{c} .$$

The input data transformation unit 103 divides the input data into (nₕ×n_{c}) in the width direction and folds them in the channel direction. In the example shown in FIG. 10, (nₕ×n_{c})=4. The input data transformation unit 103 arranges multiple data obtained by division in a state where margins are provided between the data. Note that the input data transformation unit 103 sets, for example, zero in the margin portions.

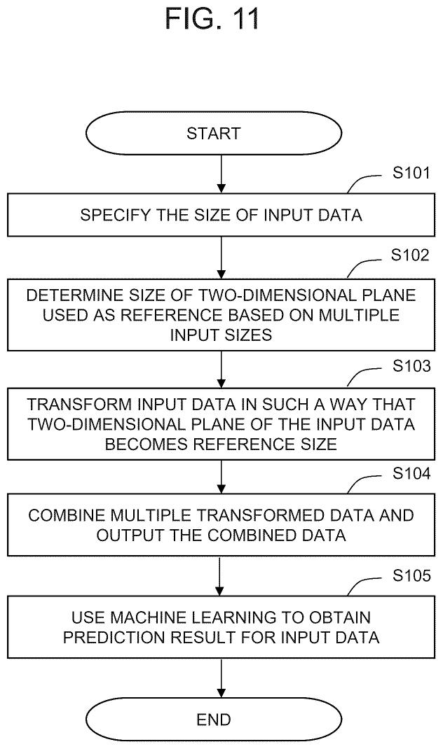

Next, operations of the inference apparatus 100 will be explained with reference to the flowchart of FIG. 11.

The input size specifying unit 101 specifies the size (input size) of each of multiple input data (step S101). The reference size calculation unit 102 determines a reference size that is the size of a two-dimensional plane used as a reference based on the input sizes (step S102). The method of determining the reference size is as explained above.

The input data transformation unit 103 transforms each input data in such a way that the two-dimensional plane of the input data becomes the reference size (step S103). That is, the input data transformation unit 103, after enlarging or reducing input data, divides the input data with respect to one or more dimensions and folds them in a direction of a dimension different from the one or more dimensions. Note that the input data transformation unit 103 may also not enlarge or reduce input data.

The data combination unit 104 combines multiple data obtained by the transformation (for example, resizing and folding) to obtain one data (step S104).

The inference unit 105 uses machine learning such as a neural network to obtain a prediction result for the input data (step S105).

As explained above, in the present example embodiment, the inference apparatus 100, based on the reference size, transforms each input data in such a way that sizes are equalized and then combines multiple input data. Therefore, when early fusion is used, loss of information is suppressed and thus a decrease in inference accuracy can be suppressed. Moreover, the effect of reducing computational cost by early fusion is not impaired.

Accordingly, the inference apparatus 100 of the present example embodiment can be utilized, as one example, to operate efficient machine-learning applications while maintaining accuracy in environments where computing resources are limited.

### Example Embodiment 2

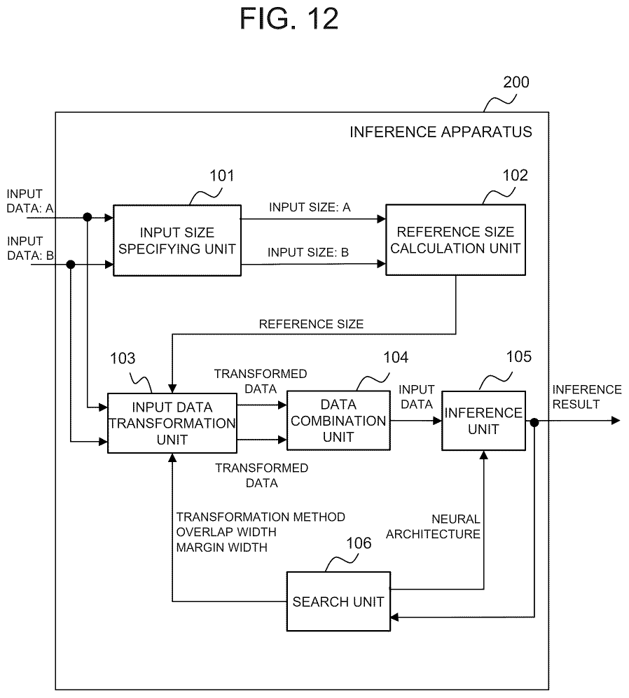

FIG. 12 is a block diagram that explains another example of a configuration of an inference apparatus. An inference apparatus 200 shown in FIG. 12 includes, in addition to the input size specifying unit 101, the reference size calculation unit 102, the input data transformation unit 103, the data combination unit 104, and the inference unit 105, a search unit 106.

The configurations and functions of the input size specifying unit 101, the reference size calculation unit 102, the input data transformation unit 103, the data combination unit 104, and the inference unit 105 are the same as those in the first example embodiment. The search unit 106 performs a search of parameters used by the input data transformation unit 103.

The search unit 106 supplies usable parameters to the input data transformation unit 103. The input data transformation unit 103 uses the supplied parameters to perform processing similar to the processing in the first example embodiment. Referring to the first example embodiment above, parameters usable by the input data transformation unit 103 include, for example, the transformation methods (transformation method 1-A, transformation method 1-B, transformation method 2), a value of overlap width in transformation method 2, and a value of margin width. However, parameters are not limited to these, and when the input data transformation unit 103 is configured to use other parameters, those other parameters can also be included in the search targets.

The search unit 106 sequentially supplies combinations of different parameters to the input data transformation unit 103. A combination of parameters is, for example, a combination such as transformation method 1-A, transformation method 2, and overlap width=10, and a combination such as transformation method 3 and margin width=10.

When any combination of parameters is supplied to the input data transformation unit 103, the input data transformation unit 103 and the data combination unit 104 execute the same processing as in the first example embodiment and output combined data to the inference unit 105. The inference unit 105 uses an inference model to obtain a prediction result for the input data.

The search unit 106 uses techniques of neural architecture search (NAS) to optimize the parameters and a neural architecture of an inference model in the inference unit 105. For example, the search unit 106 inputs prediction results from the inference unit 105. Then, the search unit 106 uses a loss of the prediction results as an objective function and updates the parameters and the neural architecture in such a way that a value of the objective function becomes small.

Note that when the inference apparatus 200 is in production operation, the search unit 106 is excluded from the inference apparatus 200. That is, the inference apparatus 200 is used in the same form as the inference apparatus 100 in the first example embodiment.

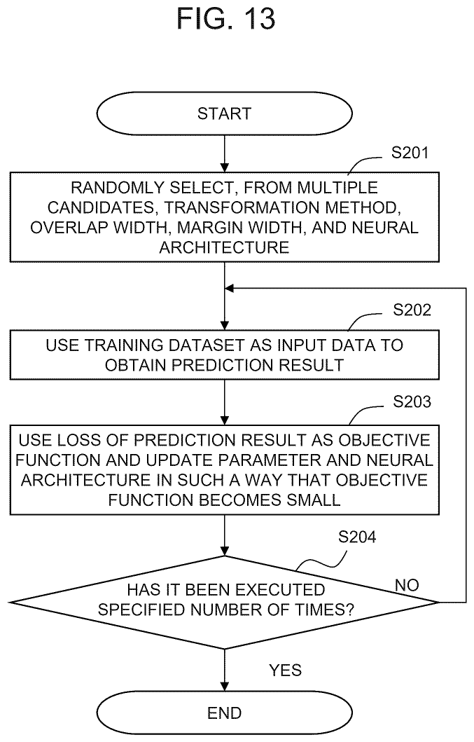

Next, operations of the search unit 106 in the inference apparatus 200 will be explained with reference to the flowchart of FIG. 13.

The search unit 106 randomly selects, from multiple candidates, a transformation method, an overlap width, a margin width, and a neural architecture (step S201).

Among the selected candidates, the search unit 106 supplies the transformation method, the overlap width, and the margin width to the input data transformation unit 103. The input data transformation unit 103 uses the supplied parameters to perform the same processing as in the first example embodiment. The search unit 106 supplies, among the selected candidates, the neural architecture to the inference unit 105. The inference unit 105 performs inference using an inference model configured with the supplied neural architecture.

The search unit 106 inputs a dataset for training that is prepared in advance to the input size specifying unit 101 and the input data transformation unit 103. A portion of the inference apparatus 200 excluding the search unit 106 performs the same processing as in the first example embodiment, and the inference unit 105 obtains a prediction result (step S202).

The search unit 106 uses a loss of the prediction result as an objective function and updates the parameters and the neural architecture in such a way that the objective function becomes small (step S203).

The search unit 106 checks whether processing of step S202 and step S203 has been executed a predetermined number of times determined in advance (step S204). When the number of executions has not reached the predetermined number of times, processing returns to step S202. When the number of executions has reached the predetermined number of times, processing is terminated.

In the present example embodiment, in addition to the effects of the first example embodiment, an effect is obtained that optimal parameters and a neural architecture can be determined.

Moreover, although the above example embodiments can be configured by hardware, they can also be achieved by a computer having a processor such as a CPU (Central Processing Unit) and a memory.

For example, a program for executing the methods (processing) in the above example embodiments is stored in a storage apparatus (storage medium), and each function may be achieved by executing, by the CPU, a program stored in the storage apparatus.

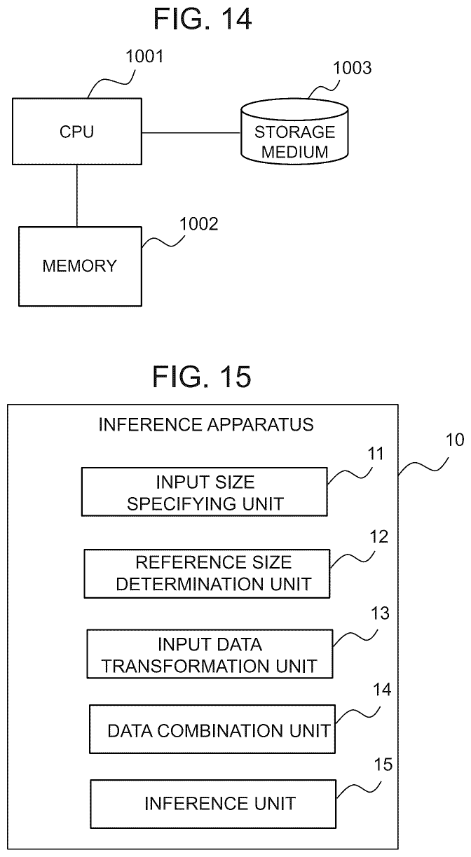

FIG. 14 is a block diagram that explains one example of a computer having a CPU. The computer is implemented in the inference apparatus 100 and the inference apparatus 200. A CPU 1001 achieves each function in the example embodiments above by executing processing in accordance with a program (software element: code) stored in a storage medium 1003. That is, the CPU 1001 achieves the functions of the input size specifying unit 101, the reference size calculation unit 102, the input data transformation unit 103, the data combination unit 104, and the inference unit 105 in the inference apparatus 100 shown in FIG. 1. The CPU 1001 also achieves the functions of the input size specifying unit 101, the reference size calculation unit 102, the input data transformation unit 103, the data combination unit 104, the inference unit 105, and the search unit 106 in the inference apparatus 200 shown in FIG. 12.

Functions of the inference apparatus 100 and the inference apparatus 200 can also be achieved by cooperation of multiple processors (computers). Functions of the inference apparatus 100 and the inference apparatus 200 can also be achieved by cooperation of a CPU and a GPU (Graphics Processing Unit).

The storage medium 1003 is, for example, a non-transitory computer readable medium. The non-transitory computer-readable medium includes various types of tangible storage media. Specific examples of non-transitory computer-readable media include magnetic recording media (for example, a hard disk), magneto-optical recording media (for example, a magneto-optical disk), a CD-ROM (Compact Disc-Read Only Memory), a CD-R (Compact Disc-Recordable), a CD-R/W (Compact Disc-ReWritable), and a semiconductor memory (for example, a mask ROM, a PROM (Programmable ROM), an EPROM (Erasable PROM), and a flash ROM).

A program may also be stored in various types of transitory computer-readable media. For transitory computer-readable media, for example, a program may be supplied via a wired communication line or a wireless communication line, that is, via an electric signal, an optical signal, or an electromagnetic wave.

A memory 1002 is realized, for example, by a RAM (Random Access Memory) and serves as a storage unit that temporarily stores data when the CPU 1001 executes processing. A form is also conceivable in which a program held in the storage medium 1003 or a transitory computer-readable medium is transferred to the memory 1002 and the CPU 1001 executes processing based on the program in the memory 1002. Note that the storage medium 1003 and the memory 1002 may be integrated.

FIG. 15 is a block diagram that explains principal components of an inference apparatus. An inference apparatus 10 shown in FIG. 15 includes an input size specifying unit 11 that specifies the size of each of multiple input data (which is achieved by the input size specifying unit 101 in the example embodiments), a reference size determination unit 12 that determines a reference size (which is achieved by the reference size calculation unit 102 in the example embodiments), an input data transformation unit 13 that transforms the input data based on the reference size to generate multiple transformed data (which is achieved by the input data transformation unit 103 in the example embodiments), a data combination unit 14 that combines the transformed data into one data (which is achieved by the data combination unit 104 in the example embodiments), and an inference unit 15 that performs inference using one data as input (which is achieved by the inference unit 105 in the example embodiments).

A part or all of the above example embodiments can also be described as the following Supplementary note, but are not limited to the following.

### (Supplementary Note 1)

An inference apparatus including:
an input size specifying unit that specifies a size of each of multiple input data;
a reference size determination unit that determines a reference size;
an input data transformation unit that transforms the input data based on the reference size to generate multiple transformed data;
a data combination unit that combines the transformed data into one data; and
an inference unit that performs inference using the one data as input.

### (Supplementary Note 2)

The inference apparatus according to Supplementary note 1, wherein
the data transformation unit resizes the input data to the reference size for one or more dimensions (for example, the height direction and the width direction) and arranges the resized data in a direction of a dimension different from the one or more dimensions (for example, the channel direction).

### (Supplementary Note 3)

The inference apparatus according to Supplementary note 1, wherein
the data transformation unit extracts multiple regions of the reference size from the input data, the extracted multiple regions including a region that overlaps an adjacent region, and when a remainder occurs for the size of the input data relative to the reference size, resizes the input data when transforming the input data in such a way that the remainder is eliminated.

### (Supplementary Note 4)

The inference apparatus according to Supplementary note 1, wherein
the data transformation unit combines transformed data into one data with margins provided between multiple transformed data.

### (Supplementary Note 5)

The inference apparatus according to any one of Supplementary notes 1 to 4, further including:
a search unit (which is achieved by the search unit 106 in the example embodiments) that searches for optimal values of parameters used during transformation by the data transformation unit (for example, a transformation method, an overlap width, and a margin width) and a neural architecture of an inference model included in the inference unit.

### (Supplementary Note 6)

An inference method including:
specifying a size of each of multiple input data;
determining a reference size;
transforming the input data based on the reference size to generate multiple transformed data;
combining the transformed data into one data; and
performing inference using the one data as input.

### (Supplementary Note 7)

The inference method according to Supplementary note 6, wherein the transforming includes:
resizing the input data to the reference size for one or more dimensions; and
arranging the resized data in a direction of a dimension different from the one or more dimensions.

### (Supplementary Note 8)

The inference method according to Supplementary note 6, wherein the transforming includes:
extracting multiple regions of the reference size from the input data, the extracted multiple regions including a region that overlaps an adjacent region; and
when a remainder occurs for the size of the input data relative to the reference size, resizing the input data when transforming the input data in such a way that the remainder is eliminated.

### (Supplementary Note 9)

The inference method according to Supplementary note 6, wherein
transformed data are combined into one data with margins provided between multiple transformed data.

### (Supplementary Note 10)

The inference method according to any one of Supplementary notes 6 to 9, further including:
searching for optimal values of parameters used during transformation and a neural architecture of an inference model used for inference.

### (Supplementary Note 11)

An inference program for causing a computer to execute:
specifying a size of each of multiple input data;
determining a reference size;
transforming the input data based on the reference size to generate multiple transformed data;
combining the transformed data into one data; and
performing inference using the one data as input.

### (Supplementary Note 12)

The inference program according to Supplementary note 11 causes the computer to execute:
when transforming input data, resizing the input data to the reference size for one or more dimensions; and
arranging the resized data in a direction of a dimension different from the one or more dimensions.

### (Supplementary Note 13)

The inference program according to Supplementary note 11 causes the computer to execute:
when transforming input data, extracting multiple regions of the reference size from the input data, the extracted multiple regions including a region that overlaps an adjacent region, and when a remainder occurs for the size of the input data relative to the reference size, resizing the input data when transforming the input data in such a way that the remainder is eliminated.

### (Supplementary Note 14)

The inference program according to Supplementary note 11 causes the computer to execute:
combining transformed data into one data with margins provided between multiple transformed data.

### (Supplementary Note 15)

The inference program according to any one of Supplementary notes 11 to 14 further causes the computer to execute:
searching for optimal values of parameters used during transformation and a neural architecture of an inference model used for inference.

### (Supplementary Note 16)

A non-transitory computer readable recording medium storing an inference program which, when executed by a processor, performs:
specifying a size of each of multiple input data;
determining a reference size;
transforming the input data based on the reference size to generate multiple transformed data;
combining the transformed data into one data; and
performing inference using the one data as input.

### (Supplementary Note 17)

The non-transitory computer readable recording medium according to Supplementary note 16, wherein
the inference program, when executed by a processor, performs:
when transforming input data, resizing the input data to the reference size for one or more dimensions; and
arranging the resized data in a direction of a dimension different from the one or more dimensions.

### (Supplementary Note 18)

The non-transitory computer readable recording medium according to Supplementary note 16, wherein
the inference program, when executed by a processor, performs
when transforming input data, extracting multiple regions of the reference size from the input data, the extracted multiple regions including a region that overlaps an adjacent region, and when a remainder occurs for the size of the input data relative to the reference size, resizing the input data when transforming the input data in such a way that the remainder is eliminated.

### (Supplementary Note 19)

The non-transitory computer readable recording medium according to Supplementary note 16, wherein
the inference program, when executed by a processor, performs
combining transformed data into one data with margins provided between multiple transformed data.

### (Supplementary Note 20)

The non-transitory computer readable recording medium according to any one of Supplementary notes 16 to 19, wherein
the inference program, when executed by a processor, performs
searching for optimal values of parameters used during transformation and a neural architecture of an inference model used for inference.

A part or all of the configurations described in Supplementary notes 2 to 5 that depend on Supplementary note 1 can be applied to various hardware, software, various recording means that record software, or systems, on condition that the above example embodiments are not deviated from.

Although the present disclosure has been described above with reference to example embodiments, the present disclosure is not limited to the above example embodiments. Various changes can be made to the configuration and details of the present disclosure that can be understood by those skilled in the art within the scope of the present disclosure.

1. An inference apparatus comprising:
a memory storing software instructions; and
one or more processors configured to execute the software instructions to:
specify a size of each of multiple input data;
determine a reference size;
transform the input data based on the reference size to generate multiple transformed data;
combine the transformed data into one data; and
perform inference using the one data as input.

2. The inference apparatus according to claim 1, wherein
the one or more processors configured to execute the software instructions to
resize the input data to the reference size for one or more dimensions and arrange the resized data in a direction of a dimension different from the one or more dimensions.

3. The inference apparatus according to claim 1, wherein
the one or more processors configured to execute the software instructions to
extract multiple regions of the reference size from the input data, the extracted multiple regions including a region that overlaps an adjacent region, and
when a remainder occurs for the size of the input data relative to the reference size, resize the input data when transforming the input data in such a way that the remainder is eliminated.

4. The inference apparatus according to claim 1, wherein
the one or more processors configured to execute the software instructions to
combine transformed data into one data with margins provided between multiple transformed data.

5. The inference apparatus according to claim 1, wherein
the one or more processors configured to execute the software instructions to
search for optimal values of parameters used during transformation and a neural architecture of an inference model used for inference.

6. An inference method comprising:
specifying a size of each of multiple input data;
determining a reference size;
transforming the input data based on the reference size to generate multiple transformed data;
combining the transformed data into one data; and
performing inference using the one data as input.

7. The inference method according to claim 6, wherein the transforming comprises:
resizing the input data to the reference size for one or more dimensions; and
arranging the resized data in a direction of a dimension different from the one or more dimensions.

8. The inference method according to claim 6, wherein the transforming comprises:
extracting multiple regions of the reference size from the input data, the extracted multiple regions including a region that overlaps an adjacent region; and
when a remainder occurs for the size of the input data relative to the reference size, resizing the input data when transforming the input data in such a way that the remainder is eliminated.

9. The inference method according to claim 6, wherein
transformed data are combined into one data with margins provided between multiple transformed data.

10. A non-transitory computer readable medium storing an inference program which, when executed by a processor, performs:
specifying a size of each of multiple input data;
determining a reference size;
transforming the input data based on the reference size to generate multiple transformed data;
combining the transformed data into one data; and
performing inference using the one data as input.

11. The inference apparatus according to claim 2, wherein
the one or more processors configured to execute the software instructions to
search for optimal values of parameters used during transformation and a neural architecture of an inference model used for inference.

12. The inference apparatus according to claim 3, wherein
the one or more processors configured to execute the software instructions to
search for optimal values of parameters used during transformation and a neural architecture of an inference model used for inference.

13. The inference apparatus according to claim 4, wherein
the one or more processors configured to execute the software instructions to
search for optimal values of parameters used during transformation and a neural architecture of an inference model used for inference.
